(19) United States
(12) Patent Application Publication
(10) Pub. No.: US 2015/0379248 A1
(43) Pub. Date: Dec. 31, 2015

(54) Online Biometric Authentication without Saving Biometric Data

(71) Applicant: V. Gorelik, Brooklyn, NY (US)

(72) Inventors: Victor Gorelik, Brooklyn, NY (US); Natalia Hanson, Brooklyn, NY (US)

(21) Appl. No.: 14/315,305

(22) Filed: Jun. 25, 2014

(51) Int. Cl. G06F 21/32; G06F 21/34; H04L 29/06

(52) U.S. Cl. CPC G06F 21/32; H04L 63/0861; H04L 63/0853; G06F 21/34

(57) ABSTRACT

The invention provides a device and a method for biometric user authentication during client-server communication. The device is a sensor for recording of a user's biometric data and an access card which belongs to the user. The method is based on the user's representation on the server by an array of random numbers unrelated to the user's biometric data. The information recorded on the access card is the array of coefficients calculated in such a way that applying these coefficients to the biometric data of the user produces the array of random numbers saved on the server.

### CROSS REFERENCE TO RELATED APPLICATIONS

Not applicable.

### STATEMENT REGARDING FEDERALLY SPONSORED RESEARCH AND DEVELOPMENT

Not applicable.

### REFERENCE TO SEQUENCE LISTING, A TABLE, OR A COMPUTER PROGRAM LISTING COMPACT DISC APPENDIX

Not applicable.

### TECHNICAL FIELD

This invention relates to authentication of a user in a client-server communication.

### BACKGROUND

There are different authentication schemes in computer security that allow user to login to the server. They are based on security credentials e.g., a password or a fingerprint or an access card provided by the user at the client.

In these schemes a user's biometry can be used in order to increase the security of communications. However, using biometric data puts the user's privacy in danger since storing biometric data long term (even in encrypted form) introduces the possibility that at some moment of time it will be revealed or decoded.

### SUMMARY

It is therefore the objective of the present invention to provide a device and the method for client-server communication where the login to the server is based on user's biometric data, but the biometric data itself is not saved in any form neither on the server, nor on the client.

The proposed device is comprised of a biometric sensor located client-side, e.g. a webcam used to make pictures of the user's palm, and the access card with information recorded during enrollment.

The proposed method is based on server-side representation of the user by an array of random numbers unrelated to the user's biometric data. The information on the access card is an array of coefficients calculated in such a way that applying these coefficients to the biometric data of the user (e.g. to his palm's image) produces the array of random numbers saved on the server.

The advantage of the method is that real biometric data cannot be retrieved even theoretically from data of the server or of the client if they are compromised.

### BRIEF DESCRIPTION OF THE DRAWINGS

FIG. 1 illustrates the process of enrollment.

FIG. 2 illustrates the process of authentication.

FIG. 3 illustrates extracting array Z from various user biometric data: face image, palm image, signature, and audio recording.

### DETAILED DESCRIPTION OF THE INVENTION

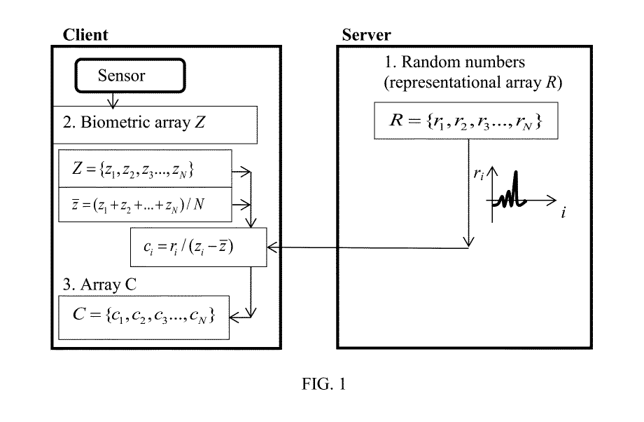

FIG. 1 illustrates the process of enrollment.

An array R={r₁, r₂, r₃ . . . , r_{N}} of random numbers (not related to biometric data of the user) is generated on the server. The array R represents the user at the server.

Biometric data of the user is collected on the client as an array Z of N components: Z={z₁, z₂, z₃ . . . , z_{N}}. Example technique for extracting a biometric array from the user's face image is given in section [0024], from the user's palm image—in section [0025], from the signature—in section [0026], and from the audio-record—in section [0027].

An array C={c₁, c₂, c₃ . . . , C_{N}} is saved on the user's access card; the values of cᵢ are calculated using the formulas:

c₁=r₁/(z₁− z̅),

c₂=r₂/(z₂− z̅),

. . . ,

c_{N}=r_{N}/(z_{N}− z̅), (1)

where z̅=(z₁+z₂+ . . . +z_{N})/N (average of Z). Per formulas in (1), R=(Z− z̅)C.

If one of the components of the array Z is equal to its average (e.g., z₁= z̅), then the calculation of C using the formulas (1) is impossible (division by zero). Such a situation can be easily avoided. As an example, if all zᵢ values are between 0 and 1, then introducing N more artificial points z_{N+1}, z_{N+2}, z_{N+3}, . . . , z_{2N} calculated by the formula z_{N+1}=3−zᵢ to the array Z solves the problem by making z̅=1.5 and different from all 2N values of zᵢ. N more random numbers of rᵢ have to be appended to the array R as well.

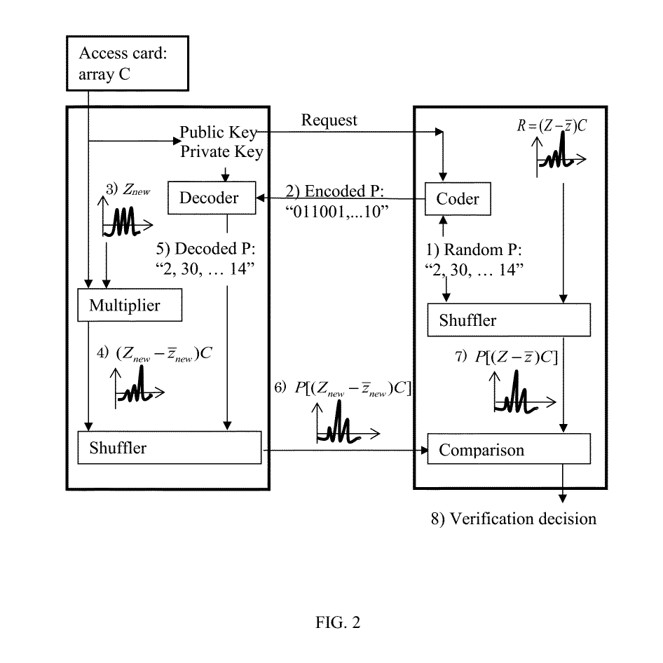

FIG. 2 illustrates the process of authentication.

When the user submits an access card, a random public/private pair is generated at the client side (for RSA encryption; see U.S. Pat. No. 4,405,829). The public key is sent to the server along with the connection request.

Then, the server performs the following operations (numerated in FIG. 2):
1) Generates a random permutation P of N integers (from 1 to N), for example, for N=32: “2, 30, 4, 1, 5, 7, 6, 8, 16, 15, 28, 13, 9, 10, 11, 12, 20, 19, 18, 17, 21, 23, 22, 24, 32, 31, 3, 29, 25, 26, 27, 14”.
2) Encodes this string using the public key and sends the encoded permutation to the client.

After that, the client performs the following operations:
3) Extracts a biometric array Z_{new} from the image of the user's palm (as described in sections [0023]-[0027]).
4) Builds an array R_{new}=(Z_{new}− z̅_{new})C, where is the average of the array Z_{new} and C are the coefficients from the access card, which were created during enrollment.
5) Decodes the permutation P from the received encoded string using the private key.
6) Applies the decoded permutation P to R_{new} and submits the array P[R_{new}] to the server. Note that when Z_{new}=Z, P[R_{new}] is exactly equal to P[R].

After that, the server performs the following operations:
7) Applies the generated permutation P to the representational array R=(Z− z̅)C, which was created on the server during enrollment.
8) Calculates the correlation coefficient between the array P[R] and the array P[R_{new}] submitted by the client and makes the verification decision.

If the correlation coefficient is sufficiently close to 1 (e.g., greater than 0.7), the server grants authorization; otherwise, the user's access to the server is denied.

The reason that the correlation coefficient is required to be close to 1 is as follows. If the average values of two arrays A and B are equal to zero (as is the case for A=(Z− z̅) and B=(Z_{new}− z̅_{new})) and the correlation coefficient between the arrays A and B is equal to 1, then after the multiplication of each of the arrays by the same array C (component-by-component), the correlation coefficient between the arrays {a₁*c₁, a₂*c₂, a₃*c₃, . . . , a_{N}*c_{N}} and {b₁*c₁, b₂*c₂, b₃*c₃, b_{N}*c_{N}} is equal to 1 as well; shuffling the last two arrays in the same order also does not change their correlation coefficient. If this correlation coefficient is equal to 1, it means Z=const*Z_{new}. If the correlation coefficient is close to 1, it means Z and Z_{new} are probably derived from the biometric data of the same user.

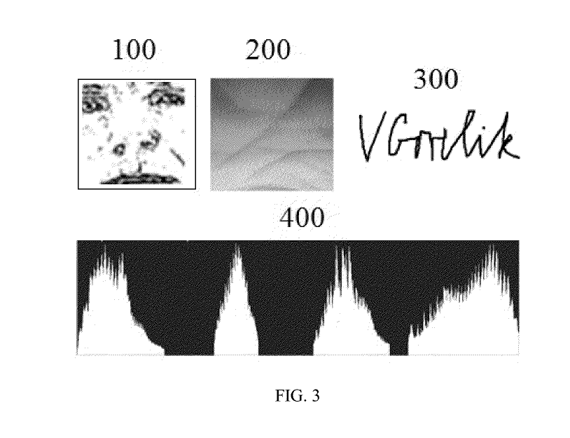

FIG. 3 illustrates a way of extracting array Z from various biometric data: a face image, a palm image, a signature, and an audio recording.

The face image 100 can be represented as a frame of 48×48 pixels (see U.S. patent application Ser. No. 13/936,190) so that the biometric array Z is represented as the array {zᵢ} of the brightness values of the pixels in the frame, where 0<=zᵢ<255 and N=48*48 to account for each pixel in the frame.

The palm 200 can be presented in a similar manner, see U.S. patent application Ser. No. 14/034,274.

User's signature 300 can be presented as three arrays

X={x₀, x₁, x₂, . . . , x_{K-1}}

Y={y₀, y₁, y₂, . . . , y_{K-1}}

T={t₀, t₁, t₂, . . . , t_{K-1}}

where K is a number of data points in the signature, X corresponds to the x-coordinates and Y corresponds to the y-coordinates of the points of the signature registered on each “mouse move”—at the moments T. The triplet sequence Z={x₀, y₀, t₀, x₁, y₁, t₁, . . . , x_{K-1}y_{K-1}, t_{K-1}}, where N=3*K is an example of biometric array Z extracted from the user's signature. The pair sequence Z={x₀, y₀, x₁, y₁, . . . , x_{K-1}, y_{K-1}}, where N=2*K is another example of biometric array Z, see U.S. Pat. No. 8,060,752 and U.S. Pat. No. 7,783,893.

In the case of the audio recording 400 array Z is a sequence of N volume intensities in the phrase “My secrete word” pronounced by a user. For the audio recording in FIG. 3 N-1024.

The last step of deriving Z is “twisting” it: the sequence Z={z₁, z₂, z₃ . . . , z_{N}} is shuffled and the value of each zᵢ is multiplied by a random number between 0 and 1. The shuffle pattern and the multipliers are determined based on the information extracted from the user's access card or based on other source of information that a hacker cannot have. This is done in order to protect the real biometry of the user: if the hacker knows both the array C and the array R, he can calculate Z, but this Z will be not real, but twisted, biometry.

The security of the proposed system is very difficult to compromise for the following reasons.

To get access to the server, the hacker has to produce the permuted representational array; having just the representational array is not enough for that. The hacker can intercept an encoded permutation string sent from the server, but he has to decode it in order to build a permuted representational array. However, the corresponding private key to do that is not available to him since it is not stored anywhere (it is an internal variable of a program running on the client). So the hacker can only use the trial and error method. In the proposed scheme, he has just one attempt to break encryption per response because private and public keys and permutations are randomly generated for each request.

The advantages of the proposed method are as follows:
the user is represented on the server only by an array of random numbers that are not related to his biometric data, and his real biometric data cannot be retrieved even theoretically from the data on the server or the client alone if either is compromised;
the method uses randomly generated private and public keys that are not saved anywhere and a random permutation that is different for each request/response, so there is no need for the user to create/memorize/store any passwords; there is also no need to store any helper data.

Although the present invention has been described in terms of the preferred application, it is to be understood that the disclosure is not to be interpreted as limiting. Various modifications will become apparent to those skilled in the art after having read this disclosure. For example, the described device and method can be used to restrict access to facilities. Other examples: using the device and method for voting machines and ATMs. It is intended that the appended claims be interpreted as covering all alterations and modifications in the spirit and within scope of the invention.

1. A device for biometric user authentication during client-server communication comprised of a sensor in the form of camera for recording of an image of a user's palm and an individual access card belonging to the user.

2. A two-step method for biometric user authentication on the device of claim 1: the enrollment and user login,
where the enrollment step comprises:
generating and saving to the server the array of random numbers R={r₁, r₂, r₃, r_{N}} representing the user, where N is the number of components in the array R;
extracting a biometric array Z={z₁, z₂, z₃, . . . , z_{N}} from the image of the user's palm recorded by the camera;
calculating, on the client, the array of multiplier coefficients C={c₁, c₂, c₃, . . . , c_{N}}, where cᵢ=rᵢ/(zᵢ− z̅_{z}) and z̅=(z₁+z₂+ . . . +z_{N}) / Nis the average of components of Z;
writing the values of C={c₁, c₂, c₃, . . . , c_{N}} to the user's access card;
and the login step comprises:
submitting, on the client, the access card and extracting values of C={c₁, c₂, c₃, . . . , c_{N}};
generating, on the client, a random private/public key pair;
submitting the public key to the server;
generating a random permutation of N integers on the server;
encoding the permutation with the help of the public key on the server;
sending the encoded permutation to the client;
recording an image of the user's palm by the camera on the client;
extracting on the client a biometric array Z_{new} from the image of the user's palm;
calculating on the client a representational array R_{new}=(Z_{new}− z̅_{new} )C (component by component multiplication), where z̅_{new} is an average of components of Z_{new};
decoding on the client with the help of the private key the encoded permutation received from the server;
applying on the client the decoded permutation to the array R_{new};
submitting the permuted array to the server;
applying the permutation created on the server to the array R saved on the server;
comparing this permuted array against the array submitted by the client;
making the verification decision based on the correlation coefficient between these two arrays: the user is verified positively if the coefficient is greater than 0.7.

3. The device for biometric user authentication of claim 1 comprised of a sensor in the form of camera for recording the image of the user's face.

4. A method for biometric user authentication of claim 2 on device of claim 3 comprising a step of extracting biometric array Z from the image of the user's face recorded during enrollment, and a step of extracting biometric array Z_{new} from the image of the user's face recorded during login of a user to the server.

5. The device for biometric user authentication of claim 1 comprised of a sensor in the form of a screen to record the user's signature.

6. A method for biometric user authentication of claim 2 on device of claim 5 comprising a step of extracting biometric array Z from the user's signature recorded during enrollment, and a step of extracting biometric array Z_{new} from user's signature recorded during login of a user to the server.

7. The device for biometric user authentication of claim 1 comprised of a sensor in the form of a microphone to record the user's voice.

8. A method for biometric user authentication of claim 2 on device of claim 7 comprising a step of extracting biometric array Z from the user's audio recorded during enrollment, and a step of extracting biometric array Z_{new} from user's audio recorded during login of a user to the server.
